(19) United States
(12) Patent Application Publication
(10) Pub. No.: US 2003/0218619 A1
(43) Pub. Date: Nov. 27, 2003

(54) System and method for interactive rotation of pie chart

(75) Inventor: Yariv Ben-Tovim, Bellevue, WA (US)

Correspondence Address: MERCHANT & GOULD, P.O. BOX 2903, MINNEAPOLIS, MN, 55402-0903, US

(73) Assignee: Microsoft Corporation, Redmond, WA (US)

(21) Appl. No.: 10/153,292

(22) Filed: May 21, 2002

(51) Int. Cl. G09G 5/00

(52) U.S. Cl. 345/649

(57) ABSTRACT

The present invention is directed at a simplified system and method for rotating the origin of a pie chart. Briefly stated, the system and method allow a user to rotate the pie chart directly from the principal graphical representation of the pie chart, without resorting to other data entry screens or windows. More specifically, the invention enables a data analysis software product to present a graphical representation of data, such as a pie chart, and with a single user input alter the origin of the graphical representation of the data. In other words, once the data analysis software product has displayed the pie chart, the user can rotate the pie chart directly, with a single user input, and without resort to other data entry screens or windows.

### BACKGROUND OF THE INVENTION

One of the biggest factors considered in the design and development of software applications is ease of use. Often the difference between a successful software application and an unsuccessful software application is decided by the user's experience in interacting with it. Because of this, software developers strive to simplify the user's experience.

One particularly competitive segment of the software industry is data analysis software. Data analysis software deals with analyzing data and presenting the data to the user in a meaningful way. Typically, data analysis software includes mechanisms to generate graphical representations of the data, such as pie charts, bar charts, line graphs, and the like. Some data analysis software includes rich features for making those graphical representations appealing to view and simple to create. For example, data analysis software that generates pie charts may include the ability to alter the color of the pie slices, change the size of the pie chart, and alter other visual features of the pie chart. One feature of a pie chart that may be modifiable is the “origin” of the chart. For the purpose of this discussion, the origin corresponds to the location along the perimeter of the pie chart at which slices of the pie begin. In other words, the corresponding to the first slice of the pie chart begins at the origin of the pie chart.

When picking an origin for rendering slices of the pie chart, typical data analysis software defaults to 90 degrees (the vertical most position). Advanced data analysis tools may include the ability for a user to programmatically alter the origin for the slices. For example, the user may wish to rotate the pie chart such that the first slice begins at 30 degrees or 80 degrees or any other arbitrary angle. Such a rotation may improve the aesthetics of the pie chart, make labels more visible, or the like.

Although existing data analysis software includes the ability to rotate the pie chart, they typically require several user interactions to achieve the rotation. For example, at least one data analysis software product allows the user, once a pie chart has been created, to invoke a child window having a smaller representation of the pie chart. The child window may identify for the user the current origin of the pie chart (e.g., 90°), and include an input field allowing the user to manually select a new origin. Unfortunately, this type of mechanism takes the user's attention away from the original pie chart and moves it to another window. The user must then interact with the other window to alter the starting point of the pie chart. In addition, the user must perform some action to invoke the other window, thereby detracting slightly from the user's experience. Although this is a useful tool, given the competitiveness of data analysis software products, it is less than an ideal solution to the problem.

### SUMMARY OF THE INVENTION

The present invention is directed at a simplified system and method for rotating the origin of a pie chart. Briefly stated, the system and method allow a user to rotate the pie chart directly from the principal graphical representation of the pie chart, without resorting to other data entry screens or windows. More specifically, the invention enables a data analysis software product to present a graphical representation of data, such as a pie chart, and with a single user input alter the origin of the graphical representation of the data. In other words, once the data analysis software product has displayed the pie chart, the user can rotate the pie chart directly, with a single user input, and without resort to other data entry screens or windows.

### BRIEF DESCRIPTION OF THE DRAWINGS

FIG. 1 is a functional block diagram illustrating components of a software environment in which the present invention may be implemented.

FIG. 2 is a graphical representation of an input device having a rotational input mechanism, as may be used in implementations of the invention.

FIG. 3 is an illustrative screen shot of a user interface that may be presented by the data analysis application of FIG. 1, in accordance with one implementation of the invention.

FIG. 4 is another illustrative screen shot of the user interface presented by the data analysis application of FIG. 1, in accordance with one implementation of the invention, having a pie chart rotated in response to a rotate input notification generated by a wheel mouse.

FIG. 5 is a logical block diagram generally illustrating a process for modifying an origin of a pie chart without resort to an additional input window.

### DETAILED DESCRIPTION OF THE PREFERRED EMBODIMENT

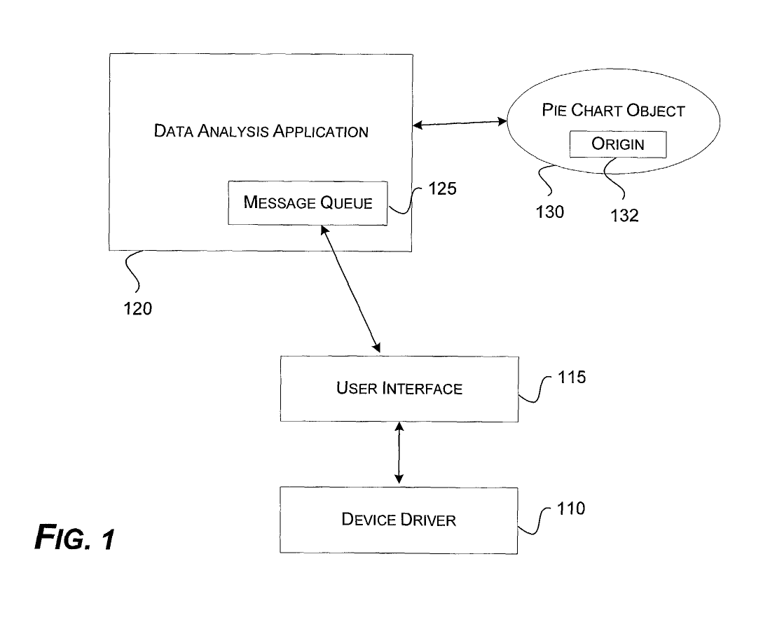

FIG. 1 is a functional block diagram illustrating components of a software environment in which the present invention may be implemented. Shown in FIG. 1 is a data analysis application 120 that includes analytical functions as well as other functions to enable a user to manipulate and understand data. In one example, the data analysis application 120 may be a spreadsheet application or the like. One function of the data analysis application may be to create images that graphically represent data. For instance, tables of numerical data may not convey meaningful information to a user until the data is presented in a graphical way. Bar charts, line charts, pie charts, and the like are typical graphical representations of data. In this implementation, the data analysis application 120 is configured to generate a pie chart from tabular data. FIG. 1 illustrates the pie chart as a pie chart object 130 having many properties associated with the pie chart. Those properties may include a size of the pie chart, colors associated with each slice, various labels that may be shown on the pie chart, and an origin 132. The data analysis application 120 includes mechanisms, described in greater detail below, for modifying the properties of the pie chart object 130, including the origin 132.

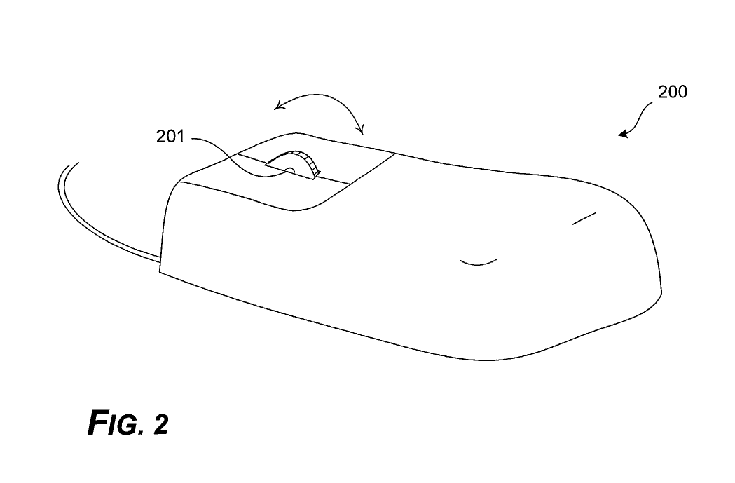

Also shown in FIG. 1 is a device driver 110 associated with an input device. In this described embodiment, the input device is a computer mouse, or similar input device, having a rotational input mechanism. Turning briefly to FIG. 2, a conventional computer mouse 200 is illustrated that may be used in implementations of the invention. As will be appreciated by those skilled in the art, the mouse 200 shown includes a rotational input mechanism (e.g., a wheel) 201. Such a conventional wheel mouse 200 typically is used to scroll documents up and down in a software application, such as word processing documents or the like. As will be appreciated, if the wheel 201 is rotated in either direction, a signal is issued to the device driver 110 by the mouse 200. The signal indicates the direction in which the wheel 201 was rotated and the amount of the rotation. Other signals may also be issued by the mouse 200, such as to indicate movement of the mouse 200 or the pressing of one or more buttons on the mouse 200.

Returning to FIG. 1, signals from the input device are received by the device driver 110. In the case where the device driver 110 corresponds to a wheel mouse, such as the one illustrated in FIG. 2, typical signals may indicate that the mouse is moving in one or more directions, that a button on the mouse has been pressed, or that the rotational input mechanism has been rotated. In response to such a signal, the device driver 110 is typically configured to indicate the existence of the signal to an operating system, often referred to as “firing” or “raising” an “event.” The operating system may then handle the event in any conventional manner. Often, in the case of input device drivers, a user interface module 115 retrieves the signal from the device driver 110. The user interface module 115 may then make the signal available to other software modules that have indicated an interest in the particular event raised.

Most software applications, such as the data analysis application 120, receive user input events, including those received from a mouse. Typically, software applications include a message queue 125 into which the user interface module 115 posts signals from input devices. In the current example, a signal from an input device, such as the wheel mouse, is received by the device driver 110, retrieved from the device driver 110 by the user interface module 115, and posted to the message queue 125 of the data analysis application 120. At that point, the data analysis application 120 may handle the message in any practical way.

In accordance with the invention, the data analysis application 120 responds to messages that indicate a rotation of the rotational input mechanism on the input device by directly modifying the origin 132 of the pie chart graphic 130. In other words, if the input device is a wheel mouse, rotating the wheel causes the data analysis application 120 to rotate the origin of the pie chart. In this way, the user experience of modifying the origin of the pie chart is simplified over existing software applications.

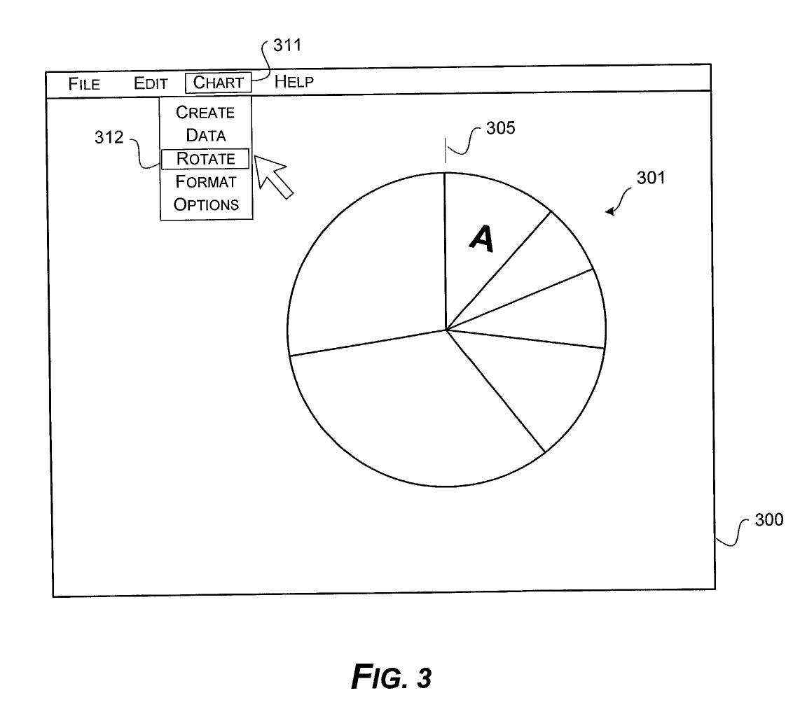

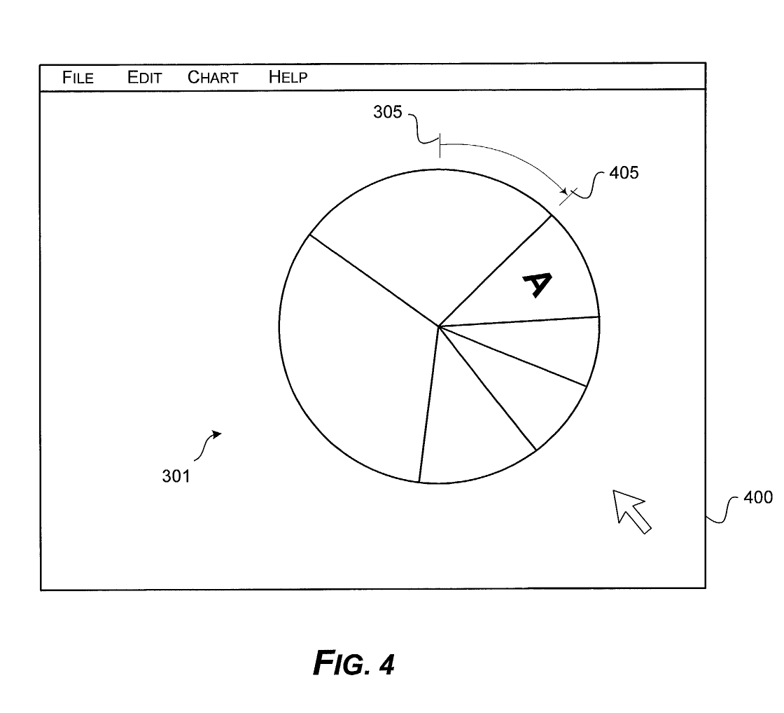

FIGS. 3 and 4 are illustrative screen shots of a user interface that may be presented by the data analysis application 120 shown in FIG. 1. Shown in FIG. 3 is a window 300 with a pie chart 301. As will be appreciated, the pie chart 301 may be a graphical representation of data maintained by the data analysis application. The pie chart 301 is composed of several slices, each slice proportionally representing its associated data. The slices of the pie chart are drawn beginning at an origin 305. More specifically, the first slice “A” of the pie chart 301 is represented by an arc beginning at the origin 305 and extending in a clockwise direction around the pie chart 301 a distance corresponding to the proportional value of the first slice “A.” The slice may then be bounded by lines extending from the center of the pie chart 301 to each end of the arc. Alternatively, different colors may be used in each slice to visually distinguish them.

Also associated with the window 300 is a menu bar 310 with a Chart option 311 and a Rotate Chart sub-option 312. In accordance with conventional data analysis applications, the origin 305 of the pie chart 301 may be modified (i.e., the pie chart may be rotated) by activating the Rotate Chart sub-option 312, thereby invoking another input window (not shown) separate from the main window 300. An input selection mechanism or field on that other input window may be used to modify the origin 305. However, that process detracts from the user's experience by taking the user's attention away from the pie chart 301 and forcing the user to perform steps in addition to those enabled by the invention. In accordance with the invention, activating a rotational input mechanism, such as the wheel of a computer mouse, causes the data analysis application to directly modify the origin 305 of the pie chart 301.

Referring now to FIG. 4, the pie chart 301 may be rotated without resort to a second input mechanism or window by simply activating the rotational input mechanism while viewing the pie chart 301. For instance, the origin 305 may be moved to a second location 405 with a simple turn of the mouse wheel. It will be apparent that the pie chart may be rotated in either direction based on the direction of rotation of the rotational input mechanism. Note that the user need not select any menu items or activate any other input window to rotate the pie chart 301. By eliminating steps from the conventional methods, the invention improves the user's experience, providing the data analysis application with an advantage.

Although described here in the context of a wheel mouse, it will be appreciated that other input devices may work suitably well also. For instance, a trackball may be used, or a pen on a touch screen that allows the user to provide a rotational input (e.g., dragging the pie chart in a circular arc). Alternatively, the input device may be a mouse and the rotational input mechanism may be pressing a key on the pie chart, as if grabbing it, and then turning the pie chart with the movement of the mouse (like a round volume button in many applications). Moreover, it is not necessary to the invention that the pie chart be rotated in opposite directions based solely on the direction of rotation of the rotational input mechanism. For example, the pie chart may be rotated in one direction by rotating the input mechanism in one direction, and in the other direction by holding down a modifier key (e.g., a Shift key or the like) while continuing to rotate the input mechanism in the same direction. These and other alternatives will become apparent to skilled artisans.

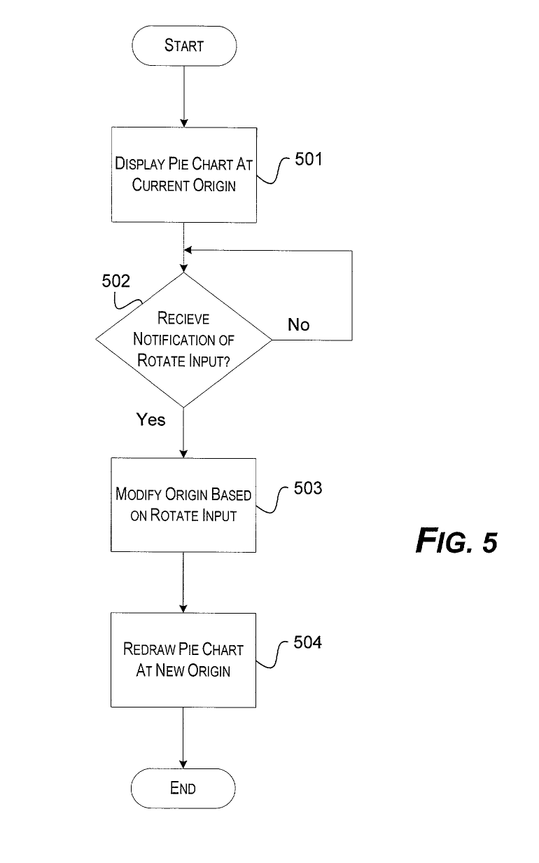

FIG. 5 is a logical block diagram generally illustrating a process for modifying an origin of a pie chart with a single input. The process 500 enters where a data analysis application includes data for representation in a pie chart, and a user input has triggered the creation of the pie chart. Processing begins at step 501.

At step 501, the process draws the pie chart to a display window of the data analysis application. As shown in FIG. 3, the display may take the form of a window having a graphical representation of the pie chart. The pie chart is drawn at a current origin, such as a default origin stored by the data analysis application, or some other predefined origin.

At step 502, the process idles until a rotate input notification is received. The rotate input notification corresponds to a signal generated by an input device having a rotational input mechanism. One example of such an input device is the conventional wheel mouse illustrated in FIG. 2. The signal generated is an indication that the rotational input mechanism has experienced a rotation, such as by a user turning the wheel of the wheel mouse. The signal may include a direction of the rotation, if applicable. One alternative signal may be generated by the rotation of a ball within a trackball. Other alternatives also exist and will be apparent to those skilled in the art. It will also be appreciated that although the process 500 idles at step 502, many other tasks may be performed by the data analysis application unrelated to the rotation of the pie chart. If the rotate input notification is detected, the process moves to step 503.

At step 503, the origin of the pie chart is modified based on the rotate input notification. As mentioned, the rotate input notification may include a direction of rotation. Based on that information, the value of the origin is modified accordingly. The amount (e.g., the number of degrees) by which the origin is modified may be based on a default value or may be computed in some other way. For instance, the data analysis application may maintain a value for the number of degrees by which to rotate the pie chart in response to each rotate input notification event. It will be appreciated that as a user continues to rotate the wheel of the mouse, multiple signals may be generated for each predetermined increment by which the wheel is rotated. A rotational value (or gradient) may be repeatedly applied for each rotational increment experienced. For instance, a single rotational increment may result in a 10 degree rotation, while three rotational increments may result in a 30 degree rotation (i.e., 3 times 10 degrees). The value of the rotational increment may be predefined or user selectable. Once the origin of the pie chart has been properly modified, the process 500 continues to step 504.

At step 504, the data analysis application redraws the pie chart with the first slice beginning at the modified origin, and the process 500 ends. It will be appreciated that the process shown allows a user to modify the origin of the pie chart without resort to a separate input window. The user may directly rotate the pie chart without the prior need to bring up a special input window or mechanism to alter the origin. It will be appreciated that the system and method enabled by the present invention simplifies interaction with the data analysis application, thereby improving the user's experience.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method for modifying an origin of a graphical representation of data in a data analysis application, comprising:
displaying the graphical representation having a first origin, the first origin identifying a location on the graphical representation;
without presenting an input window associated with the origin, receiving an input notification indicating that a rotate event has occurred, the rotate event being associated with an input device having a rotational input mechanism;
based on the input notification, modifying the first origin to a second origin; and
redrawing the graphical representation having the second origin.

2. The computer-implemented method of claim 1, wherein the first origin is based on a default value associated with the data analysis application.

3. The computer-implemented method of claim 2, wherein the first origin is a starting point for a first boundary of a portion of the graphical representation.

4. The computer-implemented method of claim 1, wherein the graphical representation comprises a pie chart and the first origin is a property of the pie chart.

5. The computer-implemented method of claim 4, wherein the location identified by the first origin comprises a boundary of a slice on the pie chart.

6. The computer-implemented method of claim 1, wherein the input device comprises a wheel mouse and wherein the rotate event corresponds to a rotation of the wheel.

7. The computer-implemented method of claim 1, wherein modifying the first origin to the second origin comprises adjusting a value of the first origin by an increment of rotation associated with the rotational input mechanism.

8. The computer-implemented method of claim 7, wherein the rotational input mechanism comprises a wheel of a mouse, and wherein the increment of rotation associated with the wheel corresponds to a predetermined amount of modification to the value of the first origin.

9. A method for rotating a pie chart displayed by a data analysis application, the method comprising:
displaying the pie chart in a window associated with the data analysis application, the pie chart comprising a plurality of slices, an initial slice having a first boundary located at a first origin, the first origin being based on a default value;
receiving an input notification that a rotate event has occurred, the rotate event occurring without resort to a separate input window, the input notification including an indication of direction; and
rotating the pie chart in a direction corresponding to the direction indicated by the input notification such that the pie chart is redrawn with the initial slice having the first boundary located at a second origin, the second origin being based on the default value as modified by information associated with the input notification.

10. The method of claim 9, wherein the input notification is received from an input device having a rotational input mechanism, and wherein the indication of direction corresponds to a rotation of the rotational input mechanism.

11. The method of claim 10, wherein the input device comprises a computer mouse, and wherein the rotational input mechanism comprises a rotational wheel.

12. The method of claim 9, wherein rotating the pie chart comprises modifying the first origin by the information associated with the input notification to achieve the second origin.

13. The method of claim 12, wherein modifying the first origin further comprises identifying a rotational value associated with an increment of rotation of the rotational input mechanism and applying the rotational value to the first origin to achieve the second origin.

14. The method of claim 13, wherein the rotational input mechanism comprises a wheel of a computer mouse.

15. The method of claim 13, wherein the rotational input mechanism comprises a ball of a trackball.

16. The method of claim 9, wherein the information associated with the input notification comprises an amount of rotation to be applied to the origin per increment of rotation of the rotational input mechanism.

17. A system for displaying a pie chart, comprising:
a data analysis application including a rotation module programmed to modify an origin associated with a graphical representation of data, the origin indicating a starting location at which portions of the graphical representation are drawn, the rotation module being further programmed to receive a rotation message indicative of the occurrence of a rotation event, the rotation event corresponding to an activation of a rotational input mechanism on an input device, the rotation message being issued without resort to a separate input window for modification of the origin.

18. The system of claim 17, wherein the graphical representation of data comprises a pie chart, and wherein the portions of the pie chart comprise slices of the pie chart.

19. The system of claim 17, wherein the input device comprises a computer mouse, and wherein the rotational input mechanism comprises a wheel of the mouse.

20. The system of claim 19, wherein the activation of the wheel comprises a rotation of the wheel by an increment, and wherein the modification of the origin is based on an rotational value associated with the increment.

21. The system of claim 17, wherein the modification of the origin causes the portions of the graphical representation to be drawn at a starting location that differs from the unmodified origin by an incremental value.

22. The system of claim 21, wherein the graphical representation comprises a pie chart, and wherein the modification of the origin by the incremental value causes the pie chart to be redrawn in a rotated state relative to the pie chart having the unmodified origin.

23. The system of claim 22, wherein the redrawn pie chart is rotated in a first direction relative to the pie chart having the unmodified origin.

24. The system of claim 23, wherein the redrawn pie chart is rotated in a second direction relative to the pie chart having the unmodified origin, the second direction being opposite of the first direction.
